(19) United States
(12) Patent Application Publication
(10) Pub. No.: US 2005/0085567 A1
(43) Pub. Date: Apr. 21, 2005

(54) Flame retardant spiral crimp polyester staple fiber

(75) Inventors: Stephen W. Foss, Rye Beach, NH (US); Robert Sawvell, Irmo, SC (US)

Correspondence Address: PERKINS, SMITH & COHEN LLP, ONE BEACON STREET, 30TH FLOOR, BOSTON, MA, 02108, US

(73) Assignee: Foss Manufacturing Co., Inc., Hampton, NH (US)

(21) Appl. No.: 10/917,817

(22) Filed: Aug. 13, 2004

Related U.S. Application Data
(60) Provisional application No. 60/495,771, filed on Aug. 15, 2003.

(51) Int. Cl. C08K 5/53; C08K 7/02

(52) U.S. Cl. 523/222; 523/122

(57) ABSTRACT

Bi-component spiral crimped flame retardant fibers, and methods of manufacture thereof, are provided with side-by-side (10, 12) and core-sheath (14) arrangements of extruded PET materials having differing intrinsic viscosities. This difference leads to differential shrinkage and crimping through heating during manufacture of the fiber arrangement. Only one of the components exhibits flame-retardant qualities, the qualities imparted by flame-retardant additives (20) or polymers. Other embodiments include anti-microbial additives (22) interspersed in at least one of the extrusions.

### CROSS-REFERENCE TO RELATED APPLICATIONS

The present application claims the benefit of priority to U.S. Provisional Patent Application Ser. No. 60/495,771 filed Aug. 15, 2003, the contents of which are incorporated herein by reference.

### BACKGROUND OF THE INVENTION

There is presently a need for flame retardant fibers to be used in various products such as such as mattresses, pillows, comforters, quilts and the like. Conjugate fibers, such as those producible by the equipment disclosed in U.S. Pat. No. 5,511,960 (the '960 patent), are used today in pillows, but none are flame retardant or composed of PET.

### SUMMARY OF THE INVENTION

The present invention relates generally to fiber, and, more particularly, to a fiber having crimp with flame retardant (FR) properties, which may also have anti-microbial (and/or anti-fungal) properties, all of which continue to be exhibited by the fiber even when used in a fabric product after repeated launderings/uses.

The present invention provides a bi-component fiber having a side-by-side, core/sheath, or other configurations (e.g. pie-wedge.) One arrangement uses binder fibers, which are staple fiber or filament type.

Limiting the presence of a flame retardant agent to just one of the components of the fiber reduces the amount of the flame retardant agent needed to meet governmental standards. Fibers in accordance with the present invention may be used for flame retardant pillows, for example, and provide excellent burn test results.

The present invention provides a flame-retardant, polyester (i.e., PET) conjugate staple fiber produced using side-by-side co-extrusion technology that imparts a spiral crimp that is very resilient or crush-resistant. The highly resilient flame retardant fiber of the present invention may be used as fiber fill for bedding applications such as pillows, comforters, mattress pads and Duvet covers.

The conjugate fiber may be formed using commercially-available flame retardant additives or flame retardant polymers. The conjugate fiber is typically formed using polymers that have differential shrinkage properties extruded in a side-by-side configuration. Differences in relative shrinkage properties of extruded polymers can be obtained through selection of polymers having high and low relative intrinsic viscosities (IV), through the introduction of additives, or through adjustments in extrusion manufacturing techniques. During heat setting, one component of the bi-component fiber shrinks more than the other, causing crimping between the components.

In one embodiment of the present invention, a flame-retardant PET having an IV of 0.62 was selected to form one component of the fiber, and a standard PET having an IV of 0.70 was chosen to form the other component. The range of IV's can vary from 0.50 to 0.80. In this embodiment, the flame-retardant PET includes agents therein such as phosphorus to impart the flame-resistant property.

In another embodiment of the present invention, anti-microbial (and/or anti-fungal) additives are preferably interspersed in the PET of the non-flame-retardant component of the conjugate fiber, although such anti-microbial additives could easily have been added to the flame-retardant component.

By varying the amount of flame retardant and plain PET utilized in the conjugate fiber, the fiber design can be optimized to meet flame retardant standards economically, by more efficiently controlling the amount of flame retardant additive needed. Concentrating the flame-retardant additive to less than the entire conjugate fiber reduces the amount of the additive required to be used in regions of the fiber where the additive may not be efficacious. It also eliminates the need for blending equipment at the pillow manufacturer.

### BRIEF DESCRIPTION OF THE FIGURES

Other objects, features and advantages will be apparent from the following detailed description of preferred embodiments taken in conjunction with the accompanying figures, wherein:

FIGS. 1 and 2 are cross-section views of side-by-side bi-component configurations of a flame-retardant fiber in accordance with the present invention; and

FIG. 3 is a cross-section view of a core-sheath bi-component configuration of a flame-retardant fiber in accordance with the present invention.

### DESCRIPTION OF PREFERRED EMBODIMENTS OF THE INVENTION

The flame-retardant conjugate fiber of the present invention is preferably composed of PET polymer(s) in conjunction with commercially-available flame retardant additives or flame retardant polymers. The spiral crimp in the fiber is typically created by using polymers that have differential shrinkage extruded in a side-by-side configuration. This differential shrinkage can also be obtained by using polymers with high and low intrinsic viscosity (IV), additives, or manufacturing techniques. During heat setting, one side of the fiber shrinks more than the other and this causes the crimp.

In one embodiment of the present invention, the flame retardant PET has an intrinsic viscosity of 0.62 and the plain PET has an intrinsic viscosity of 0.70. The range of intrinsic viscosity can vary from 0.50 to 0.80.

An additional embodiment of the present invention provides anti-microbial additives and properties preferably, though not exclusively, to the non-flame retardant PET component of the conjugate fiber. The processing of polymers to form anti-microbial fibers is described in U.S. Pat. No. 6,723,428, the contents of which are incorporated herein by reference.

Two types of flame retardant PET have been used in connection with the present invention, although other types are also suitable. KOSA (formerly HOECHST) produces a PET polymer by adding phosphorus during polymerization, much like adding titanium dioxide. EASTMAN and many others have developed phosphorus concentrates that can be added to PET during extrusion, and there are several flame retardant PET's being developed by companies such as CLARIANT and CIBA.

Typically, the flame retardant PET has a lower relative intrinsic viscosity of between 0.58 and 0.64 and is extruded at a temperature of 280-290° C. However, it could be designed to exhibit the higher intrinsic viscosity of the fiber components if additives are employed.

The non-flame retardant PET is typically 0.65-0.75 and is extruded between 285 and 300° C. A standard side-by-side spinneret may be utilized to form the conjugate fiber. Spun yarns between 2.2 and 10 dTex (2-9 denier) have been produced. Outputs ranging from 4,500 to 6,500 pounds/hour have been obtained with take-up speeds of 400 to 1600 meters per minute.

The fibers may be pigmented to produce solution dyed fibers and UV stabilizers and anti-microbial concentrates may also be added to enhance the performance characteristics.

Typically, the fibers are then drawn on a conventional fiber draw-line and stretched between 3 and 4.5 times their length to orient and impart strength. The fibers are then mechanically crimped and placed in a heat setting oven. The oven temperature may be controlled between 140° and 185° C. to create the spiral crimp as the low intrinsic viscosity shrinks more than the high intrinsic viscosity. It is also possible not to heat-set the fiber at this point to leave latent shrinkage that can be activated in a later process (after making the quilt or pillow) if desired.

The intrinsic viscosity upper limit is approximately 0.85 as the temperature starts to rise. Extruders may be sufficiently large that they can handle intrinsic viscosity's as high as 1.0, but the temperature differential gets too far apart for quality fibers. A higher intrinsic viscosity could be used in both sides, if desired. On the low intrinsic viscosity side, fibers have been produced using the present invention down to 0.53, although at this level the fiber strength is reduced.

It is possible to produce this fiber with flame retardant PET on one side and a low melt such as PE, PP, or PETG on the other side. This would provide a flame retardant binder fiber for use in quilts, and the like.

It is also possible to put PCT on one side creating a phenomenally resilient fiber, although this adds to the expense.

There are also additives available that can increase the intrinsic viscosity during extrusion.

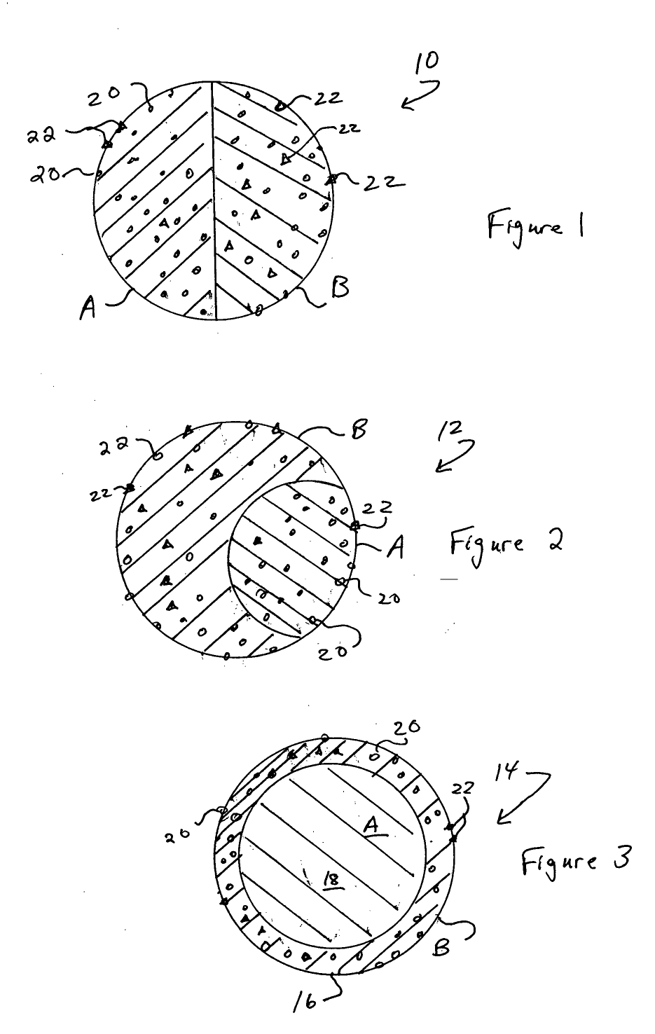

FIGS. 1 and 2 show two different side-by-side fiber configurations that may result from processes following the general process descriptions above. FIG. 1 illustrates a configuration 10 in which the first fiber component A and the second fiber component B are each semi-hemispheric in shape. FIG. 2 illustrates a configuration 12 in which the second fiber component B partially encompasses the circumference of the first fiber component A. Other configurations are possible. For example, FIG. 3 illustrates a bi-component fiber in a core-sheath configuration 14, wherein the flame-retardant PET composes the sheath 16 totally encompassing the core 18. One design objective is to employ as little flame retardant PET in the sheath 16 as required to impart sufficient flame resistance yet providing control in unsophisticated processes such as the manufacture of pillows, comforters, quilts, mattresses where such manufacturers do not have precision blending equipment. In each of the figures, flame-retardant agents 20 and anti-microbial additives 22 are illustrated as particles interspersed in one of the components.

It will now be apparent to those skilled in the art that other embodiments, improvements, details, and uses can be made consistent with the letter and spirit of the foregoing disclosure and within the scope of this patent application.

1. A spiral crimped flame retardant fiber, comprising:
a side by side bi-component fiber arrangement including
a first fiber of PET having an intrinsic viscosity of from about 0.50 to about 0.80, and
a second fiber of PET having an intrinsic viscosity of from about 0.50 to about 0.80, the first fiber having a higher intrinsic viscosity than the second fiber, said fibers thereby having a differential shrinkage and having been crimped by using heat during manufacture of the fiber arrangement;
only one of said fibers having been provided with flame retardant qualities.

2. A fiber as defined in claim 1, wherein at least one of said fibers is provided with anti-microbial properties.

3. A fiber as defined in claim 1, wherein the flame retardant quality is provided by a flame retardant additive.

4. A fiber as defined in claim 3, wherein the additive is phosphorus.

5. A fiber as defined in claim 1, wherein the flame retardant quality is provided by a flame retardant polymer.

6. A fiber as defined in claim 1, wherein the fiber with flamed retardant characteristics has an intrinsic viscosity of about 0.62 and the other fiber has an intrinsic viscosity of about 0.70.

7. A spiral crimped flame retardant fiber, comprising:
a side by side bi-component fiber arrangement including
a first fiber of PET having a predetermined shrinkage characteristic, and
a second fiber of PET having a different predetermined shrinkage characteristic, said fibers having been crimped by using heat during manufacture of the fiber arrangement;
only one of said fibers having been provided with flame retardant qualities.

8. A fiber as defined in claim 7, wherein at least one of the fibers is provided with anti-microbial properties.

9. A fiber as defined in claim 7, wherein the flame retardant quality is provided by a flame retardant additive.

10. A fiber as defined in claim 9, wherein the additive is phosphorus.

11. A fiber as defined in claim 1, wherein the flame retardant quality is provided by a flame retardant polymer.

12. A fiber as defined in claim 1, wherein the fiber with flame retardant characteristics has an intrinsic viscosity of about 0.62 and the other fiber has an intrinsic viscosity of about 0.70.

13. A fiber as defined in claim 7, wherein both fibers have intrinsic viscosities of 0.50 to 0.80.

14. A method for making a spiral crimped flame retardant fiber, comprising the steps of:
provided a first fiber of PET having an intrinsic viscosity of from about 0.50 to about 0.80;
providing a second fiber of PET having an intrinsic viscosity of from about 0.50 to about 0.80, the first fiber having a higher intrinsic viscosity than the second fiber, said fibers thereby having a differential shrinkage;
extruding said fibers in a side by side configuration to provide a spiral crimp thereto; and
providing only one of said fibers with flame retardant qualities.

15. A method as defined in claim 14, wherein the flame retardant quality is provided by a flame retardant additive.

16. A method as defined in claim 14 wherein the flame retardant quality is provided by a flame retardant polymer.

17. A method for making a spiral crimped flame retardant fiber comprising the steps of:
providing a first fiber of PET having a predetermined shrinkage characteristic;
providing a second fiber of PET having a different predetermined shrinkage characteristic;
extruding said fibers in a side by side configuration to provide a spiral crimp thereto; and
providing only one of said fibers with flame retardant qualities.

18. A spiral crimped flame retardant fiber, comprising:
a core/sheath bi-component fiber arrangement including
a sheath component of PET having an intrinsic viscosity of from about 0.50 to about 0.80, and
a core component of PET having an intrinsic viscosity of from about 0.50 to about 0.80, the sheath component having a higher intrinsic viscosity than the core component, said components thereby having a differential shrinkage and having been crimped by using heat during manufacture of the fiber arrangement;
only one of said components having been provided with flame retardant qualities.

19. A fiber as defined in claim 18, wherein at least one of said components is provided with anti-microbial properties.

20. A fiber as defined in claim 18, wherein the flame retardant quality is provided by a flame retardant additive.

21. A fiber as defined in claim 20, wherein the additive is phosphorus.

22. A fiber as defined in claim 18, wherein the flame retardant quality is provided by a flame retardant polymer.

23. A fiber as defined in claim 18, wherein the component with flamed retardant characteristics has an intrinsic viscosity of about 0.62 and the other of the components has an intrinsic viscosity of about 0.70.

24. A spiral crimped flame retardant fiber, comprising:
a core/sheath bi-component fiber arrangement including
a sheath component of PET having a predetermined shrinkage characteristic, and
a core component of PET having a different predetermined shrinkage characteristic, said components having been crimped by using heat during manufacture of the fiber arrangement;
only one of said components having been provided with flame retardant qualities.

25. A fiber as defined in claim 24, wherein at least one of the components is provided with anti-microbial properties.

26. A fiber as defined in claim 24, wherein the flame retardant quality is provided by a flame retardant additive.

27. A fiber as defined in claim 26, wherein the additive is phosphorus.

28. A fiber as defined in claim 24, wherein the flame retardant quality is provided by a flame retardant polymer.

29. A fiber as defined in claim 24, wherein the component with flame retardant characteristics has an intrinsic viscosity of about 0.62 and the other of the components has an intrinsic viscosity of about 0.70.

30. A fiber as defined in claim 24, wherein both components have intrinsic viscosities of 0.50 to 0.80.

31. A method for making a spiral crimped flame retardant fiber, comprising the steps of:
provided a first PET material having an intrinsic viscosity of from about 0.50 to about 0.80;
providing a second PET material having an intrinsic viscosity of from about 0.50 to about 0.80, the first PET material having a higher intrinsic viscosity than the second PET material, said first and second materials thereby having a differential shrinkage;
extruding said first and second PET materials in a sheath/core configuration to provide a spiral crimp thereto; and
providing only one of said PET materials with flame retardant qualities.

32. A method as defined in claim 31, wherein the flame retardant quality is provided by a flame retardant additive.

33. A method as defined in claim 31, wherein the flame retardant quality is provided by a flame retardant polymer.

34. A method for making a spiral crimped flame retardant fiber comprising the steps of:
providing a first PET material having a predetermined shrinkage characteristic;
providing a second PET material having a different predetermined shrinkage characteristic;
extruding said first and said second PET materials in a sheath/core configuration to provide a spiral crimp thereto; and
providing only one of said PET materials with flame retardant qualities.
